(19) United States
(12) Patent Application Publication
(10) Pub. No.: US 2012/0271569 A1
(43) Pub. Date: Oct. 25, 2012

(54) ULTRASONIC FLOW METER

(75) Inventor: Michael A. Wilson, Tallassee, AL (US)

(73) Assignee: Neptune Technology Group, Inc., Tallassee, AL (US)

(21) Appl. No.: 13/404,681

(22) Filed: Feb. 24, 2012

Related U.S. Application Data
(63) Continuation-in-part of application No. 13/090,980, filed on Apr. 20, 2011.

(51) Int. Cl. G06F 19/00; G06F 15/00

(52) U.S. Cl. 702/48; 702/130

(57) ABSTRACT

A method and apparatus for measuring fluid flow in a conduit using ultrasonic transducers. A periodic signal is transmitted from a first transducer and received at a second transducer, and from the second transducer to the first. For each transmission, the phase difference between the signal as transmitted and received is measured. The rate of fluid flow in the conduit can be computed from the phase relationships of the transmitted and received signals.

This application claims priority to and the benefit of U.S. patent application Ser. No. 13/090,980, filed Apr. 20, 2011, entitled “Ultrasonic Flow Meter.”

### TECHNICAL FIELD

The invention relates generally to the field of measurement instrumentation, to a method of measuring the relationship between transmitted and received ultrasonic signals to measure a desired parameter, and in particular to metering devices to measure fluid flow.

### BACKGROUND

Various mechanisms have been developed for use in meters to translate flow of a fluid, such as water or oil, to a measurable quantity. One such mechanism is an ultrasonic flow meter.

The typical prior art ultrasonic flow meter positions pairs of ultrasonic transducers on a segment of pipe or conduit, with one transducer located upstream and the other downstream with respect to the direction of fluid flow in the pipe. Each pair of ultrasonic transducers typically sends and receives an ultrasonic pulse, or series of ultrasonic pulses, back and forth. That is, the first transducer in the pair generates a pulse, or series of pulses, which is received by the other transducer. The time of flight of each pulse, or the average time of flight of the pulses in the series of pulses, is measured. The second ultrasonic transducer then sends a pulse, or series of pulses, to the first transducer. Again, the time of flight is measured. The fluid flow causes the pulses traveling downstream (i.e., with the fluid flow) to move faster, and those traveling upstream (i.e., against the fluid flow), to move slower, than the speed of sound in the static fluid. Thus, as is known in the art, the rate of flow can be determined based upon the difference in flight time between the pulses moving downstream and those moving upstream. Because the speed of sound in a fluid is dependent on the temperature of the fluid, accuracy of the meter can vary with temperature if the meter is not calibrated to temperature.

Prior art meters suffer from a number of disadvantages. The arrival time of each pulse must be detected with high accuracy, if the meter is to be accurate. This requires timing precision much smaller than the period of the ultrasonic signal if acceptable resolution is to be achieved, which causes the meters to be expensive. Also, it can be difficult to determine exactly at what point the pulse begins, as received by the receiving transducer. This requires high bandwidth as well, making the system susceptible to noise. Calibration to temperature may require static flow conditions to determine the speed of sound at a given temperature, and also may be based upon factory settings and conditions that are difficult to reproduce in the field.

Thus, there exists a need for an ultrasonic fluid meter which is not dependent upon calibration in response to temperature changes, that does not require high bandwidth electronics, and which uses simplified electronics with increased resistance to noise. The present invention satisfies these needs by providing a method and apparatus including an ultrasonic meter that measures the phase difference between the transmitted and received ultrasonic signals between two transceivers, in both the upstream and downstream directions, with feedback allowing for automatic adjustment of the transmitted signal to accommodate temperature variations.

### SUMMARY

Embodiments of the present invention satisfy these needs. One embodiment is a method of measuring the rate of flow of fluid in a conduit having first and second ultrasonic transducers positioned a known distance apart. A first periodic signal is transmitted from the first transducer and received at the second transducer, and the phase difference between the signal as transmitted and received is measured. A second periodic signal is transmitted in the opposite direction of flow, that is from the second transducer to the first transducer. Again, the phase difference between the transmitted and received signals is measured. The rate of fluid flow in the conduit is computed based upon the phase differences of the transmitted and received signals. In a preferred embodiment, the phase differences are repeatedly measured for a multiplicity of cycles of the periodic signals, and the computation of fluid flow is based upon an averaging of the repeated measurements. The phase differences of the signals may be measured by detecting zero crossings of the signals, that is, where the amplitude of the signal is zero. The frequency of the transmitted signals may be adjusted to maintain approximately a desired number of half cycles of the signal between the transducers in response to changes in the temperature of the fluid.

Another embodiment of the present invention is an apparatus for measuring the flow of a fluid in a conduit. This embodiment comprises a signal source generating a periodic drive signal that drives a pair of ultrasonic transducers, causing each transducer to transmit an ultrasonic signal through the conduit. Each transducer receives the ultrasonic signal transmitted by the other transducer. A circuit measures the phase relationships between the transmitted and received signals, and a processor computes the rate of flow of fluid in the conduit based upon the phase relationships of the signals. In a preferred embodiment, the circuit generates a first detection signal when the amplitude of the first received signal is a reference value and a second detection signal when the amplitude of the second received signal is the reference value. The reference value is preferably zero, such that the circuit detects zero crossings of the transmitted and received signals. The circuit may be implemented with comparators having a reference value set to zero. In one embodiment, the apparatus includes a counter that provides timing information concerning the phase relationship of the transmitted and received signals over a multiplicity of cycles of the signals. The apparatus may also include a phase locked loop coupled to the phase detection circuitry and to the signal source, where the phase locked loop sets the frequency of the signal source to maintain an approximately integral number of half cycles of the drive signal between the transducers in response to variations in the temperature of the fluid.

### BRIEF DESCRIPTION OF THE DRAWINGS

The present invention will be explained, by way of example only, with reference to certain embodiments and the attached Figures, in which:

FIG. 1 is a sectional view of a representation of a meter comprising an embodiment of the present invention;

FIG. 2 is a block diagram of the embodiment of FIG. 1;

FIG. 3A illustrates, as voltage versus time, a transmitted signal measured at the transmitter, the transmitted signal as received and measured at an upstream transducer, the transmitted signal as received and measured at a downstream transducer, in zero flow conditions, in which one received signal is inverted from the other for illustration purposes;

FIG. 3B illustrates the signals of FIG. 3A in the presence of flow;

FIG. 4 is an expanded view of a portion of the signals of FIG. 3B, where the received upstream and downstream signals are not inverted from one another; and

FIG. 5 illustrates a portion of the signals of FIG. 3B, with the output of the comparators of FIG. 2 superimposed, to illustrate the relationship between these signals.

### DETAILED DESCRIPTION

One embodiment of the present invention comprises an ultrasonic fluid meter in which two ultrasonic transducers, one positioned upstream and one positioned downstream, transmit and receive periodic signals to one another. Each transducer receives the signal transmitted by the other. The speed of sound in the fluid, the flow rate, and temperature of the fluid can independently be determined based upon analysis of the phase difference between the transmitted and received signals, as described in more detail below. It should be noted that while the exemplary embodiment below is described with respect to measuring the flow of water, the apparatus and method of the present invention can be applied to measure the flow of any fluid, including for example, water, oil, natural gas, or chemicals.

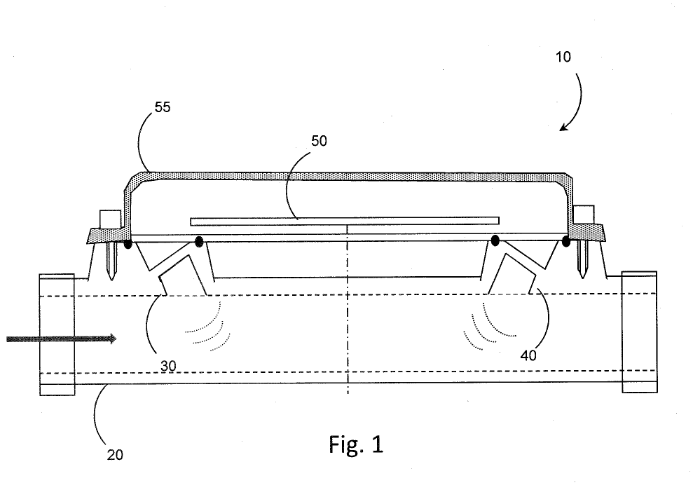

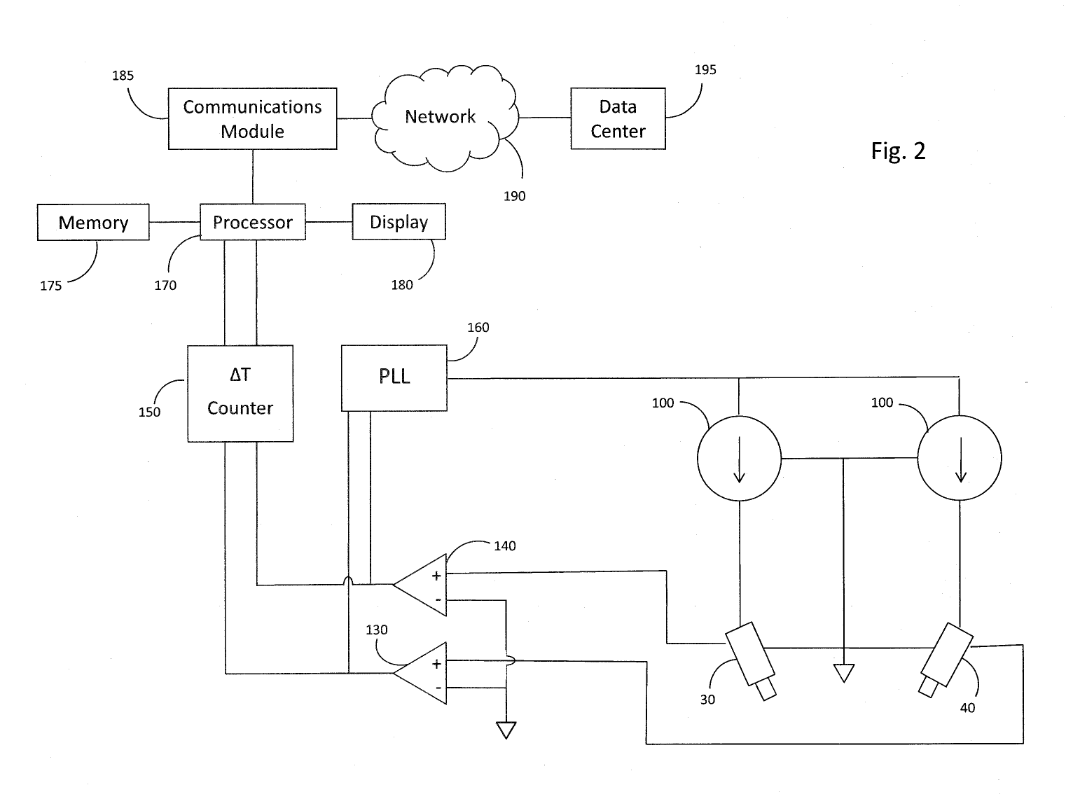

Referring to FIGS. 1-2, a meter 10 comprising an embodiment of the present invention is shown. The meter 10 includes a segment of a conduit 20 having a longitudinal axis, to which ultrasonic transducers 30 and 40 are mounted. The ultrasonic transducers are set a fixed distance away from one another, which will be referred to by the variable x. The operation of the meter 10 is not dependent on the direction of fluid flow, but for clarity and by way of example, an arrow in the conduit 20 represents the direction of fluid flow from left to right as shown in FIG. 1, and at times in this disclosure, the transducers may be referred to as upstream and downstream with respect to this direction of flow. The transducers 30 and 40 are electrically coupled to a printed circuit board 50, which contains the electronics for driving the ultrasonic transducers, and making the various measurements and calculations described herein. The printed circuit board 50 and transducers 30 and 40 are mounted in a housing 55 secured to the outside of the conduit 20.

The ultrasonic transducers 30 and 40 may be standard, commercially available ultrasonic transducers. A transducer may act as a transmitter and receiver of an ultrasonic signal. When transmitting, the transducer receives an electrical signal as an input and converts it to a corresponding ultrasonic waveform. When receiving, the transducer receives an ultrasonic waveform and converts it to a corresponding electrical signal.

In the absence of flow (zero flow), an ultrasonic signal travels at the speed of sound in the fluid, which varies by temperature. As is known in the art, an ultrasonic signal traveling upstream in a fluid, against the flow, moves slower than the speed of sound in that fluid, as the velocity of the signal is retarded by the flow. An ultrasonic signal traveling downstream, with the flow, moves faster than the speed of sound in the fluid, as the velocity of the signal is aided by the flow. Therefore, the time it takes for the signal to travel a given distance upstream is longer than the time it takes for the signal to travel the same distance downstream.

In one embodiment, transducer 30 transmits a periodic signal which is received by transducer 40; then, transducer 40 transmits a periodic signal which is received by transducer 30. For simplification of mathematics and optimization of circuitry and performance, these periodic signals are preferably at the same frequency, which is selected based upon the center operating frequency of the particular transducer used.

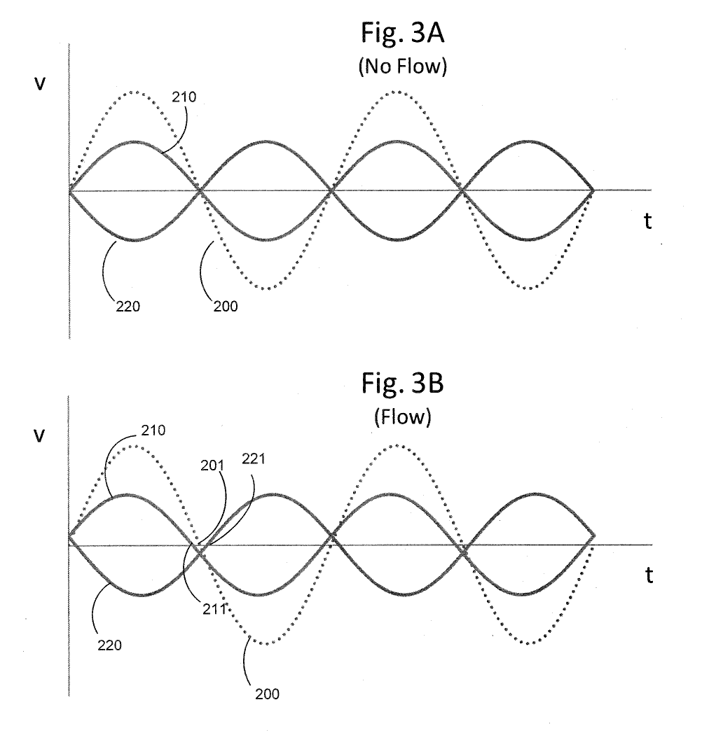

When there is no flow in the conduit, the signals are in phase. FIG. 3A illustrates three signals, the transmitted signal 200 as measured at either transducer 30 or 40 while transmitting; the first received signal 210 transmitted from the upstream transducer 30 and received and measured x distance away, at the downstream transducer 40; and the second received signal 220 transmitted from the downstream transducer 40 and received and measured x distance away, at the upstream transducer 30. In FIG. 3A, the second received signal 220 is shown as inverted for ease of illustration.

The time of flight T₀ of an ultrasonic signal traveling at the velocity of sound in a fluid, in the absence of flow, can be expressed as follows, where x is the distance traveled, V_{S} is velocity of sound in the fluid.

$${V}_{S} = \frac{x}{{T}_{0}} ,$$

such that

$${T}_{0} = \frac{x}{{V}_{S}}$$

When the ultrasonic signal is a periodic signal as preferred in embodiments of the present invention, and is more preferably a sine wave transmitting at a known frequency ƒ, T₀ may be measured as a function of the period of the sine wave:

$${T}_{0} = m * Period = \frac{m}{f} , \\ and$$

$$m = \frac{{T}_{0}}{Period} = {T}_{0} * f$$

where m is the actual number of periods and fractions of a period in T₀; and Period is the time in seconds of the period of the periodic signal with frequency ƒ.

To simplify calculations, and in a preferred embodiment, it is desirable that there be an integral number of cycles, or half cycles, of the transmitted ultrasonic signal over the distance that the signal travels at a reference temperature that is typical of an operating temperature of the meter. Here, because the ultrasonic signals are traveling between the transducers 30 and 40, that distance corresponds to the distance between the transducers. Therefore, the distance between the transducers is set to a desired value during design of the meter to provide an integral number of cycles or half cycles of the ultrasonic signal, based upon the intended center frequency of operation and the speed of sound in the fluid at the reference temperature. The intended center frequency of operation is selected based upon the resonant frequency and impedance of the ultrasonic transducer. The distance x between the transducers can be computed as follows, where c is the speed of sound in the fluid at the reference temperature, t is the time of flight of an ultrasonic signal between the transducers over the distance x under no flow conditions, N is the desired number of cycles, and ƒ is the center operating frequency:

$$c = \frac{x}{t}$$

$$x = ct , \\ and$$

$$t = \frac{N}{f}$$

$$x = c * \frac{N}{f}$$

With c equal to 1500 m/s (the speed of sound in water at room temperature), N chosen to be 15 cycles, and a center operating frequency ƒ of 150 kHz, the distance x is calculated to be 15 cm.

Thus, the distance x can be chosen to balance the operation of the meter around a desired number of integral cycles, which shall be referred to as the reference number of cycles M. The actual number of cycles m of the signal, however, will deviate from M, typically by some fraction of a cycle, as a function of temperature because the speed of sound in a fluid varies with temperature. The time represented by the deviation of the actual number of cycles m from the reference number of cycles M shall be referred to as Tₛ.

T₀=Period*M+Tₛ

When the received signal 210 is measured at the downstream transducer 40, the Tₛ value shall be referred to as T_{sA}. When the received signal 220 is measured at the upstream transducer 30, the Tₛ value shall be referred to as T_{sB}. When there is no flow present,

$${T}_{sA} = {T}_{0} - M * Period$$

$${T}_{sB} = {T}_{0} - M * Period$$

$$Therefore , \\ {T}_{sA} = {T}_{sB}$$

$${V}_{S} = \frac{x}{{T}_{0}} = \frac{x}{{T}_{sA} + M * Period} = \frac{x}{{T}_{sB} + M * Period}$$

These relationships are valid as long as the T_{sA} and the T_{sB} are in the same measurement cycle as M*Period.

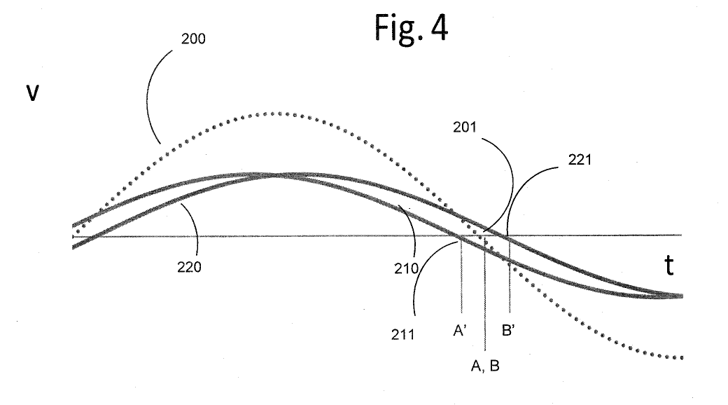

If there is flow in the conduit, there is a phase shift in both the upstream and downstream signals 210 and 220, relative to the transmitted signal 200, as shown in FIG. 3B. FIG. 4 shows in detail the phase differences between the signals as transmitted and received when flow is present in the conduit (without inversion of the signal 220 as received at the upstream transducer 40). The phase differences are marked in FIG. 4 at the zero crossings of the respective signals (that is, where the signal has zero amplitude as it crosses the x axis), and as discussed below, preferred embodiments of the apparatus and method of the present invention detect and calculate these phase differences based upon zero crossings. The phase differences also could be determined based upon other points on the waveforms. As shown, the transmitted signal 200, as measured at either transducer 30 or 40 while transmitting, has a zero crossing at time A,B. The first received signal 210, traveling downstream and measured at x distance away, has a zero crossing at point A′. The second received signal 220, traveling upstream and measured x distance away, has a zero crossing at point B′. The phase differences can be measured in time as follows:

ΔT_{A}=A−A′

ΔT_{B}=B−B′

Further, the difference in time attributable to fluid flow, ΔT_{A} and ΔT_{B}, are directly proportional to the ratio of the velocity of the fluid being measured to the velocity of sound in that fluid, as follows, where V_{W} is the velocity of the fluid (water) and V_{S} is the speed of sound in the fluid at a given temperature:

$$Δ {T}_{A} = {T}_{0} \frac{{v}_{W}}{{v}_{S}}$$

$$Δ {T}_{B} = - {T}_{0} \frac{{v}_{W}}{{v}_{S}}$$

Thus, when fluid flow is present, the time deviation represented by T_{sA} and T_{sB} includes an additional component attributable to ΔT_{A} and ΔT_{B}. This aggregate time deviation shall be referred to as T_{sAw} and T_{sBw}, respectively.

$${T}_{sAw} = {T}_{sA} + Δ {T}_{A} = {T}_{sA} + {T}_{0} \frac{{v}_{W}}{{v}_{S}}$$

$${T}_{sBw} = {T}_{sB} + Δ {T}_{B} = {T}_{sB} - {T}_{0} \frac{{v}_{W}}{{v}_{S}}$$

As discussed below, T_{sAW} and T_{sBW} may be measured directly as the phase difference between the received signals 210 and 220 and the transmitted signal 200, which preferably is measured at the zero crossings of the respective signals. Summing the above equations,

$${T}_{sAw} + {T}_{sBw} = {T}_{sA} + {T}_{sB} , \\ and$$

$${T}_{0} \frac{{v}_{W}}{{v}_{S}} - {T}_{0} \frac{{v}_{W}}{{v}_{S}} = 0$$

Then, the velocity of sound may be determined independent of velocity of fluid flow, as follows:

$${V}_{S} = \frac{2 x}{{T}_{sAw} + {T}_{sBw} + 2 M * Period}$$

The velocity of sound V_{S} in a fluid is a function of the temperature of the fluid. Once the velocity of sound in the fluid is calculated, the temperature of the fluid can be calculated. In water, V_{S}=1404.3 m/s (at 0 C)+4 m/s per degree C. Hence, it is straightforward to calculate temperature of the fluid from the velocity of sound in that fluid. Accordingly, one embodiment of the present invention includes the use of ultrasonic transducers as described to function as a temperature meter. The temperature in turn allows the measurement of the flow of heat energy in the fluid to be determined and the calculation of secondary parameters such as viscosity. Those skilled in the art will recognize that further refinements and increased accuracy can be achieved by taking into account atmospheric pressure, according to well known mathematical and physical relationships.

The mean time deviation in the received signals from the reference number of periods M is

$${T}_{smean} = {T}_{sA} + {T}_{sB} = \frac{{T}_{sAw} + {T}_{sBw}}{2}$$

Taking the difference,

$$\begin{matrix}{T}_{sAw} - {T}_{sBw} = ( {T}_{sA} + {T}_{0} \frac{{v}_{W}}{{v}_{S}} ) - ( {T}_{sB} - {T}_{0} \frac{{v}_{W}}{{v}_{S}} ) \\ = 2 {T}_{0} \frac{{v}_{W}}{{v}_{S}}\end{matrix}$$

Solving for the velocity of water,

$${V}_{W} = ( {T}_{sAw} - {T}_{sBw} ) \frac{{V}_{s}}{2 {T}_{0}}$$

$$Let$$

$$Δ {T}_{AB} = {T}_{sAw} - {T}_{sBw} , \\ then$$

$${V}_{W} = \frac{Δ {T}_{AB} * x}{2 {T}_{0}^{2}}$$

Substituting T₀=Tₛₘₑₐₙ+M*Period, then

$${V}_{W} = \frac{Δ {T}_{AB} * x}{2 {( {T}_{smean} + M * Period )}^{2}} \qquad ( Eq . 1 )$$

Thus, the velocity of the fluid may be determined by measuring T_{sAw} and T_{sBw}, from which ΔT_{AB} and Tₛₘₑₐₙ are computed.

FIG. 2 is a functional block diagram of one implementation of electronics used in the meter 10 to make these measurements and perform these computations. A signal source 100 creates a signal to drive the upstream transducer 30 and downstream transducer 40. In a preferred embodiment, there is a separate signal source 100 for each ultrasonic transducer; these sources operate from the same triggering signal and thus are synchronized. The signal sources are preferably current sources and generate a periodic signal, such as a square wave. The output of the signal source 100, in this case an alternating periodic square wave, preferably drives first one of the transducers 30 and 40 for a predefined measurement period, and then the other. The ultrasonic transducers may be modeled electrically by an LC tank circuit, such that in response to an alternating periodic square wave current input, the ultrasonic transducer oscillates and transmits a tone that is sinusoidal in nature with a frequency corresponding to the alternating input. Each transducer receives the signal transmitted by the other transducer, switching roles as the signal source 100 alternately drives the transducers.

Each transducer converts the ultrasonic signal received from the other transducer to a corresponding electrical signal. Both received signals, that is, the signal 210 received by the downstream transducer 40 and the signal 220 received by the upstream transducer 30 are coupled to electronics to measure a parameter based upon the relationship between the signals, including their phase relationship. In a preferred embodiment, when transducer 30 is being driven, the comparator 140 measures the transmitted signal 200 from transducer 30, and the comparator 130 measures the received signal 210 from transducer 40. Likewise, when transducer 40 is being driven, the comparator 130 measures the transmitted signal 200 from transducer 40, and the comparator 140 measures the received signal 220 from transducer 30. While any arbitrary point on the signals could be used as a benchmark to measure the phase relationship between the received signal and the transmitted signal, that is, T_{sAW} and T_{sBW}, to simplify measurement and calculations, in a preferred embodiment, the reference voltage of the comparators 130 and 140 is zero. The output of comparators 130 and 140 changes state when the input signal (the transmitted signal 200, the received signal 210, or the received signal 220) equals the reference voltage zero. Therefore, cycles of the signals of interest are detected and counted using zero crossings, that is, points 201, 211, and 221 where the respective signals cross the x axis on FIGS. 3B, 4. The outputs of the comparators 130 and 140 are provided to ΔT Counter 150, which provides timing information to processor 170. For ease of measurement, therefore, T_{sAw} and T_{sBw} can be measured, and ΔT_{AB} and Tₛₘₑₐₙ can be calculated, based upon the timing of the zero crossings 201, 211, and 221. With the distance x, reference number of cycles M, and period being known quantities, processor 170 may calculate the velocity of fluid flow using Equation 1 above.

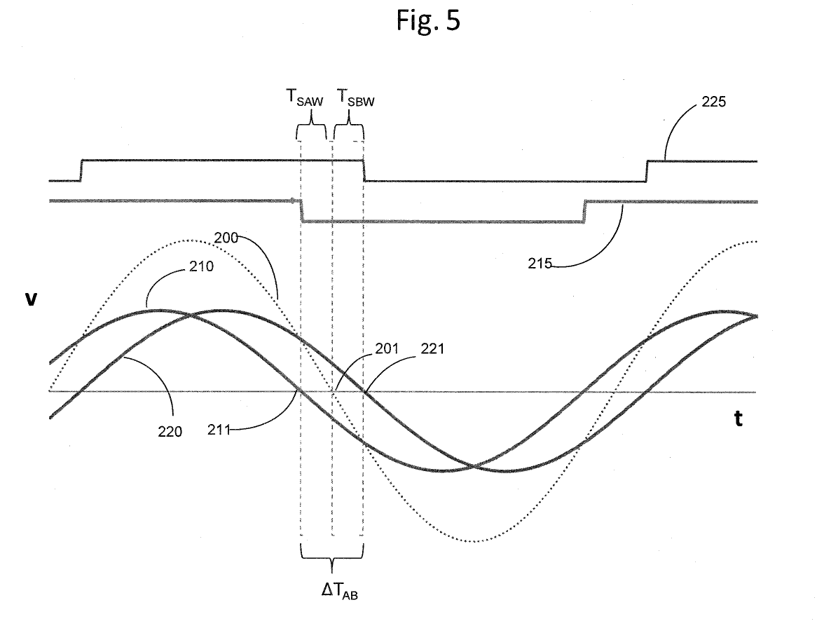

FIG. 5 illustrates the relationships of the zero crossings of the received signal 210 at the downstream transducer 40, the received signal 220 at the upstream transducer 30, and the transmitted signal 200 as measured at either transducer while transmitting to the output of the comparators 130 and 140, in a preferred embodiment. Specifically, FIG. 5 shows as voltage versus time, the received signals 210 and 220, and the transmitted signal 200, in the presence of flow. Superimposed on the graph are cycles of the outputs of comparators 130 and 140, shown as signals 215 and 225, respectfully. Note that while the timing of the signals is as illustrated, their voltage has been offset for clarity. The signal 210 traveling downstream travels the fastest and crosses the x axis first at point 211. As it crosses zero, the output signal 215 of the comparator 130 changes state, marking the zero crossing. The signal 220 travels the slowest and crosses the x axis at the point 221. As it crosses zero, the output signal 225 of the comparator 140 changes state, marking the zero crossing. The transmitted signal 200 (measured at the point of transmission) crosses zero at point 201. As shown, the difference in time between points 201 (A) and 211 (A′) equals T_{sAw}, and the difference in time between points 201 (B) and 221 (B′) equals T_{sBw}.

The foregoing describes an embodiment in which a single set of measurements and a single calculation of V_{w} is made. One of the advantages of the present invention, however, is that a multiplicity of measurements of T_{sAw} and T_{sBw} and calculations of V_{w} can be made in basically the same amount of time that a prior art ultrasonic meter makes a single time-of-flight measurement. In one embodiment of the present invention, measurements of T_{sAw} and T_{sBw} are made at each half cycle of the periodic signals over a defined measurement period; that is, every zero crossing of the signals is timed and counted during the measurement period. This allows repeated and nearly continuous calculations of V_{w}, which can be averaged to provide a highly accurate meter. Specifically, with a measurement period Tₘ=N*Period, and taking counts of T_{sAw} and T_{sBw} at each half cycle, Equation 1 becomes, for N cycles,

$${V}_{W} = \frac{Nx}{{NT}_{0}} * \frac{\frac{N Δ {T}_{AB}}{N}}{\frac{2 {NT}_{0}}{N}}$$

Gathering terms, substituting T₀=Tₛₘₑₐₙ+M*Period, and recognizing that N*Period=Tₘ, the equation can be reduced to

$${V}_{W} = \frac{( N * x ) * ( N * Δ {T}_{AB} )}{2 {( N * {T}_{smean} + M * {T}_{m} )}^{2}}$$

Summing the ΔT_{AB} and Tₛₘₑₐₙ over N cycles provides a more accurate average:

ΣΔT_{AB}=˜2NΔT_{AB}

ΣTₛₘₑₐₙ=˜2NTₛₘₑₐₙ

Substituting these relationships into the equation above, and further reducing:

$${V}_{W} = \frac{( N * x ) * ( ΣΔ {T}_{AB} )}{{( Σ {T}_{smean} + 2 M * {T}_{m} )}^{2}}$$

where x, N, and M are constants; ΔT_{AB}, Tₛₘₑₐₙ, and Tₘ are in seconds; and Tₘ is a constant for fixed frequency operation.

When implemented in conjunction with digital circuitry, ΔT_{AB}, Tₛₘₑₐₙ, and Tₘ are measured in bus clock cycles (BusClk). To convert them to seconds (or, in a preferred embodiment, nanoseconds), the measured counts are multiplied by the bus clock period (BusClkPeriod). Therefore,

ΣΔT_{AB}=ΣΔT_{AB}Cnts*BusClkPeriod

ΣTₛₘₑₐₙ=ΣTₛₘₑₐₙCnts*BusClkPeriod

Tₘ=TₘCnts*BusClkPeriod

Substituting these values into the measurement equation above yields:

$${V}_{W} = \frac{( x * \frac{N}{BusClkPeriod} ) * ( ΣΔ {T}_{AB} Cnts )}{{( Σ {T}_{smean} Cnts + 2 M * {T}_{m} Cnts )}^{2}} \qquad ( Eq . 2 )$$

where x, N, M, and BusClkPeriod are constants and TₘCnts is a constant for fixed frequency operation (in a variable frequency operation, discussed below, TₘCnts is measured directly); and ΣΔT_{AB}Cnts, ΣTₛₘₑₐₙCnts, and TₘCnts are counts at the frequency of the bus clock (FBusClk).

Typically, the temperature of the fluid will vary over time, normally within a given range. As the temperature of the fluid varies, the speed of sound in the fluid varies. In a preferred embodiment, the operating frequency of the input signal is automatically adjusted as the temperature of the fluid affects the speed of sound in order to maintain the actual number of periods m within a fraction of the reference number of periods M selected during the design of the meter. While the meter is accurate operating at a fixed frequency, adjusting the frequency as described can be helpful in development and test, and also to minimize the size of the counters involved and simply calculations.

The adjustment of the frequency may be accomplished by a phase locked loop set to lock on the frequency at which Tₛₘₑₐₙ equals zero. As shown in FIG. 2, the outputs of comparators 130 and 140 are inputs to the phase locked loop 160, from which T_{sAw} and T_{sBw} are derived. Because Tₛₘₑₐₙ=(T_{sAw}+T_{sBw})/2 and T_{sAw} and T_{sBw} are opposite in sign, the phase locked loop adjusts the frequency until the sum of T_{sAw} and T_{sBw} is zero. With Tₛₘₑₐₙ equal zero, then M*Period=T₀, that is T_{sA}−T_{sB}=0. The measurement equation reduces to

$${V}_{W} = \frac{N * Δ {T}_{AB} * x}{2 {( M * Period )}^{2}}$$

With a measurement period Tₘ=N*Period, and substituting

$$ΣΔ {T}_{AB} = \frac{ΣΔ {T}_{AB} Cnts}{fBusClk} \\ Σ {T}_{smean} = \frac{Σ {T}_{smean} Cnts}{fBusClk} \\ {T}_{m} = \frac{{T}_{m} Cnts}{fBusClk} \\ M * Period = \frac{M}{N} * NPeriods = \frac{M}{N} * {T}_{m} \\ Then , \\ {V}_{W} = \frac{xNfBusClk}{2 {M}^{2}} * \frac{ΣΔ {T}_{AB} Cnts}{{T}_{m} {Cnts}^{2}} \\ Where \\ \frac{xNfBusClk}{2 {M}^{2}} \qquad ( Eq . 3 )$$

is a constant, and ΣΔT_{AB}Cnts and TₘCnts are measured in BusClk counts.

The dimensions of the conduit 20 in which the measurements are made, and through which the fluid flows, are known. The flow rate can then be calculated based on the following formula:

Q_{fluid}=V_{W}*A

where Q_{fluid} is the flow rate, V_{w} is the velocity of water, and A is the cross sectional area of the pipe.

As shown in FIG. 2, in one embodiment, the calculations identified herein may be performed in a general purpose processor 170, having a memory 175 containing executable instructions to perform the calculation. The results of the calculations, including the speed of sound in the fluid, the flow rate of the fluid, the temperature of the fluid, Tₛₘₑₐₙ, or ΔT_{AB}, may then communicated to a user via a display 180, or communicated to a network 190 and on to a host system or data center 195 via an output device or communications module 195, using hardware and methods known in the art.

In one embodiment, the center frequency of a selected Piezo ultrasonic transducer was 192 KHz, resulting in a period of 5.2 μs. A reference number of cycles M was chosen to be 10, resulting in the distance x between transducers of 7.675 cm. With these values fixed, the other parameters of the device vary as follows with temperature:

| | Temperature (C.) | | |
|---|---|---|---|
| | 0 | 25 | 50 |
| V_{S} (m/s) | 1400 | 1500 | 1541 |
| T₀ (μs) | 54.8 | 51.2 | 49.8 |
| m (periods) | 10.53 | 9.82 | 9.56 |
| Phase variance (periods) | −0.53 | 0.18 | 0.44 |
| Phase variance (μs, Tₛ) | −2.74 | .91 | 2.28 |

Thus, T_{S} varies by approximately half a cycle. With a bus clock of 60 MHz, and taking counts every half cycle, the counts occur in 16.67 ns increments over a 100 cycle measurement period. Further prior art techniques of averaging, known to those of ordinary skill in the art, allow a resolution of approximately 100 ps to be achieved.

Although the present invention has been described and shown with reference to certain preferred embodiments thereof, other embodiments are possible. The foregoing description is therefore considered in all respects to be illustrative and not restrictive. Therefore, the present invention should be defined with reference to the claims and their equivalents, and the spirit and scope of the claims should not be limited to the description of the preferred embodiments contained herein.

What is claimed is:

1. A method of measuring the rate of flow of fluid in a conduit having first and second ultrasonic transducers positioned a known distance apart, said method comprising:
transmitting a first periodic signal from said first transducer and receiving said first signal at said second transducer;
measuring the phase difference between said first transmitted signal and said first received signal;
transmitting a second periodic signal from said second transducer and receiving said second signal at said first transducer;
measuring the phase difference between said second transmitted signal and said second received signal;
computing the rate of fluid flow based upon said phase differences.

2. The method of claim 1, wherein said periodic signals have the same frequency and said known distance corresponds to an integral number of half cycles of said transmitted signal at a reference temperature.

3. The method of claim 2, wherein the frequency of said period signals is adjusted in response to temperature changes of said fluid to maintain approximately said integral number of half cycles in response to variations in the temperature of the fluid.

4. The method of claim 1, wherein each said measurement step is repeated for a multiplicity of cycles of said periodic signals, and said computation is based upon an averaging of said repeated measurements.

5. The method of claim 4, wherein each said measurement step is repeated each half cycle of said multiplicity of cycles.

6. The method of claim 1, wherein said computation step comprises computing the average of and the difference between said phase differences.

7. The method of claim 6, wherein the frequency of said periodic signals is adjusted such that the average of said phase differences is approximately zero.

8. The method of claim 1, wherein said phase differences are measured by detecting zero crossings of said transmitted and received periodic signals.

9. The method of claim 5, wherein said phase differences are measured by detecting zero crossings of said transmitted and received periodic signals.

10. The method of claim 1, wherein the first four steps are performed substantially contemporaneously.

11. An apparatus for measuring the flow of a fluid in a conduit, comprising:
a signal source generating periodic drive signal;
a pair of ultrasonic transducers driven by said drive signal, each of said transducers transmitting an ultrasonic signal through said conduit in response to said drive signal and receiving the ultrasonic signal transmitted by the other transducer;
a circuit for measuring the phase relationships between said transmitted and received signals;
a processor for computing the rate of flow of fluid in said conduit based upon the phase relationships of said signals.

12. The apparatus of claim 11, wherein said circuit comprises a first circuit measuring the phase of the first received signal and a second circuit measuring the phase of the second received signal.

13. The apparatus of claim 12, wherein said first circuit generates a first detection signal when the amplitude of the first received signal is a reference value and said second circuit generates a second detection signal when the amplitude of the second received signal is said reference value.

14. The apparatus of claim 13, wherein said desired value is zero.

15. The apparatus of claim 14, further comprising a counter, said counter providing said processor timing information of said detection signals.

16. The apparatus of claim 14, wherein said first and second circuits each comprise a comparator with a reference voltage of zero.

17. The apparatus of claim 11, wherein said first and second ultrasonic transducers are positioned apart a distance equal to an integral number of cycles of said drive signal at a reference temperature.

18. The apparatus of claim 17, further comprising a phase locked loop coupled to said first and second circuits and to said signal source, said phase locked loop setting the frequency of said signal source to maintain an approximately integral number of half cycles of said drive signal between said transducers in response to variations in the temperature of the fluid.

19. The apparatus of claim 11, wherein said signal source drives only one of said transducers at a time.

20. The apparatus of claim 11, wherein said signal source drives said transducers simultaneously.

21. A method of measuring temperature of fluid comprising:
transmitting a first periodic signal from said first transducer and receiving said first signal at said second transducer;
measuring the phase difference between said first transmitted signal and said first received signal;
transmitting a second periodic signal from said second transducer and receiving said second signal at said first transducer;
measuring the phase difference between said second transmitted signal and said second received signal;
computing the temperature of said fluid based upon said phase differences.

22. The method of claim 21, wherein each said measurement step is repeated for a multiplicity of cycles of said periodic signals, and said computation is based upon an averaging of said repeated measurements.

23. The method of claim 21, wherein said computation step comprises computing the average of and the difference between said phase differences.

24. The method of claim 21, wherein said phase differences are measured by detecting zero crossings of said transmitted and received periodic signals.
